(19) United States
(12) Patent Application Publication
(10) Pub. No.: US 2008/0027777 A1
(43) Pub. Date: Jan. 31, 2008

(54) Purchasing cost reduction planning and checking

(76) Inventor: Tomohiko Kimiya, Saitama-ken (JP)

Correspondence Address: LAW OFFICES OF MICHAEL DRYJA, 1474 N COOPER RD #105-248, GILBERT, AZ, 85233, US

(21) Appl. No.: 11/460,983

(22) Filed: Jul. 29, 2006

(51) Int. Cl. G06F 9/46

(52) U.S. Cl. 705/8

(57) ABSTRACT

A method for purchasing cost reduction planning and checking includes receiving from a user one or more part characteristics and one or more supplier characteristics. The method determines one or more templates based on the part characteristics and the supplier characteristics received. Each template corresponds to a cost reduction plan. In response to the user selecting a desired template, the method receives from the user values for one or more parameters of the desired template. The method displays the cost reduction plan corresponding to the desired template, based on the values for the parameters of the desired template received from the user, for checking by the user.

### FIELD OF THE INVENTION

The present invention relates generally to purchasing parts from suppliers, and more particularly to reducing the costs of purchasing such parts from such suppliers.

### BACKGROUND OF THE INVENTION

Within corporations and other entities that manufacture equipment, a large number of parts usually have to be purchased in order to manufacture the items that the corporations sell. These parts are typically purchased from suppliers. To obtain the most profit, corporations are always looking to reduce the costs of the parts that they purchase from suppliers.

Usually, corporations have purchasing departments staffed by buyers. The job of the buyers is to request multiple part suppliers to provide quotes for cost estimates for parts, and then to select which supplier should be used to provide a given part. It is sometimes not as easy as selecting the supplier providing the lowest quoted price for a part to supply that part. Rather, other factors have to be examined, such as the supplier's reliability, the quality of previously provided parts by that supplier, and so on.

Experienced buyers that have relationships with a number of suppliers and that know the corporation's parts procurement history have thus historically been instrumental in reducing purchasing costs for parts from suppliers. However, it is more desirable to have purchasing cost reduction planning not depend on the personal ability or experience of a given buyer. For this and other reasons, there is a need for the present invention.

### SUMMARY OF THE INVENTION

The present invention relates to purchasing cost reduction planning and checking. A method for such purchasing cost reduction planning and checking, according to one embodiment of the invention, includes receiving from a user one or more part characteristics and one or more supplier characteristics. The method determines one or more templates based on the part characteristics and the supplier characteristics received. Each template corresponds to a cost reduction plan. In response to the user selecting a desired template, the method receives from the user values for one or more parameters of the desired template. The method displays the cost reduction plan corresponding to the desired template, based on the values for the parameters of the desired template received from the user, for checking by the user.

A system of an embodiment of the invention includes at least a database of templates and a graphical user interface. Each template corresponds to one or more unique pairs of part characteristics and supplier characteristics. Each template includes one or more parameters for which values are to be received, and logic to generate a cost reduction plan associated with the template based on the values for the parameters of the template. The graphical user interface is that by which to receive from a user the following.

First, the selection of one or more specified part characteristics and one or more specified supplier characteristics is received from the user. Second, the selection of a desired template from one or more templates matching each of one or more unique pairs of the specified part characteristics and the specified supplier characteristics is received from the user. Third, the values for the parameters of the desired template are received from the user. The graphical user interface then displays the cost reduction plan associated with the desired template, as generated by the logic of the desired template based on the values for the parameters received from the user.

An article of manufacture of an embodiment of the invention includes a tangible computer-readable medium and means in the medium. The tangible computer-readable medium may be a recordable data storage medium, or another type of tangible computer-readable medium. The means is for receiving the following from the user.

First, the means receives selection of one or more specified part characteristics and one or more specified supplier characteristics. Second, the means receives selection of a desired template from one or more templates matching each of one or more unique pairs of the specified part characteristics and the specified supplier characteristics. Third, the means receives values for one or more parameters of the desired template by which the desired template generates a corresponding cost reduction plan. The means is further for displaying the cost reduction plan corresponding to the desired template, as generated by the desired template based on the values for the parameters received from the user.

Embodiments of the invention provide for advantages over the prior art. Unlike the prior art, an effective cost reduction plan does not require that the buyer in question have to be experienced, nor does it depend on the personal ability of the buyer. Rather, the knowledge and experience of an effective buyer is essentially encapsulated within the logic of a template. Therefore, even an inexperienced buyer without personal knowledge of the corporation's parts and suppliers can generate an effective cost reduction plan.

Still other advantages, aspects, and embodiments of the invention will become apparent by reading the detailed description that follows, and by referring to the accompanying drawings.

### BRIEF DESCRIPTION OF THE DRAWINGS

The drawings referenced herein form a part of the specification. Features shown in the drawing are meant as illustrative of only some embodiments of the invention, and not of all embodiments of the invention, unless otherwise explicitly indicated, and implications to the contrary are otherwise not to be made.

FIG. 1 is a flowchart of a method for purchasing cost reduction planning and checking, according to an embodiment of the invention.

FIGS. 2A, 2B, 2C, and 2D, are diagrams depicting representative and exemplary graphical user interfaces (GUI's) by which some of the parts of the method of FIG. 1 can be performed, according to an embodiment of the invention.

FIG. 3 is a diagram of a representative system, according to an embodiment of the invention.

### DETAILED DESCRIPTION OF THE DRAWINGS

In the following detailed description of exemplary embodiments of the invention, reference is made to the accompanying drawings that form a part hereof, and in which is shown by way of illustration specific exemplary embodiments in which the invention may be practiced. These embodiments are described in sufficient detail to enable those skilled in the art to practice the invention. Other embodiments may be utilized, and logical, mechanical, and other changes may be made without departing from the spirit or scope of the present invention. The following detailed description is, therefore, not to be taken in a limiting sense, and the scope of the present invention is defined only by the appended claims.

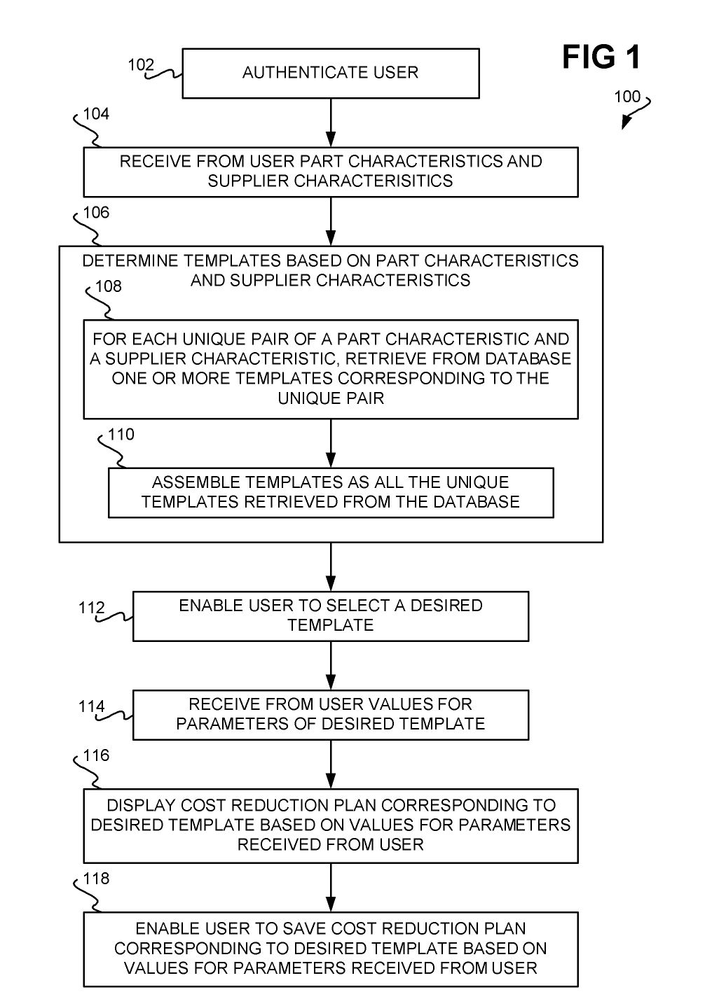

FIG. 1 shows a method 100 for purchasing cost reduction planning and checking, according to an embodiment of the invention. The method 100 may be implemented as one or more computer programs. Input may be received from a user and output may be displayed to a user via a graphical user interface.

The method 100 may first authenticate the user (102). For instance, a user may enter his or her user name and an associated password. The user name and the password may be verified against a database of previously entered user names and passwords to ensure that the user has authority to perform the method 100.

Next, the method 100 receives from the user one or more part characteristics and one or more supplier characteristics (104). The part characteristics are characteristics of the part in relation to which the method 100 is being performed. The part may be a part that the employer of the user needs in order to manufacture a given item. The part characteristics are thus the desired or specified part characteristics of this part. The supplier characteristics are characteristics of suppliers of this part. These are thus the desired or specified supplier characteristics of such suppliers of this part.

In one embodiment, the part characteristics are selected as one or more of the following. First, it is specified whether a part is multipurpose. A multipurpose part may be, for instance, one that is not particular to the item that the user's employer is manufacturing, but which can be used for many purposes. Common electrical components, such as resistors and capacitors, may be considered multipurpose parts. Second, it is specified whether a part is custom. A custom part may be one that is manufactured by a supplier solely for the user's employer in order to manufacture a given item, and is not one that is used to make other items. A small sticker indicating the model name of a given item, for instance, may be such a custom part.

Third, it is specified whether the part has a high risk of restricted supply. For instance, at various times, certain memory components, such as flash memory devices, may have very high demand throughout the industry, and thus have a high risk that their supply may be restricted on the open market. Fourth, it is specified whether the part has a high unit price. For instance, computer processors are commonly very expensive.

Fifth, it is specified whether the part requires advanced specifications. For instance, critical components may require a significant number of specifications, and thus cannot be manufactured by just any supplier. Sixth, it is specified whether the part has many components. For instance, a given part may have a large number of sub-parts or components, and may be more susceptible to price fluctuations. It is noted that some of the part characteristics may be grouped together into sub-groups, such that only one part characteristic from a given sub-group may be selected.

In one embodiment, the supplier characteristics are selected as one or more of the following. First, it is specified whether there are many suppliers for a part. Second, it is specified whether there are not many suppliers for a part. Third, it is specified whether there is only one supplier for a part. These three supplier characteristics may be grouped together into a sub-group, such that just one of these supplier characteristics may be selected. That is, a user can specify that there are many suppliers for a part, that there are not many suppliers, or that there is only one such supplier. The user cannot specify two or more of these supplier characteristics, because they are mutually exclusive.

Fourth, it is specified whether a percentage that all the parts produced by a given supplier will be purchased is high. For instance, a custom part may mean that the user's employer will purchase all or nearly all of the instances of this part made by a supplier. By comparison, a multipurpose, generic part may mean that the user's employer will not purchase all or nearly all of the instances of this part made by a supplier. Fifth, it is specified whether the supplier has a high degree of prior cooperation. For instance, the user may wish to use a supplier that his or her employer has previously worked with, and previously worked with well.

Sixth, it is specified whether the supplier has strong elemental technology and product development capability. The user may wish to use such a supplier. For example, for custom integrated circuits, it may be desired to use a supplier that has a strong background in this technology, as may be evidenced by the number of engineers that the supplier has on staff. Similarly, it may be desired to use a supplier that has product development capability. Such a supplier may be able to develop a part based on the specifications for the part provided by the user's employer, instead of being only able to manufacture the part where the complete plans are provided by the user's employer.

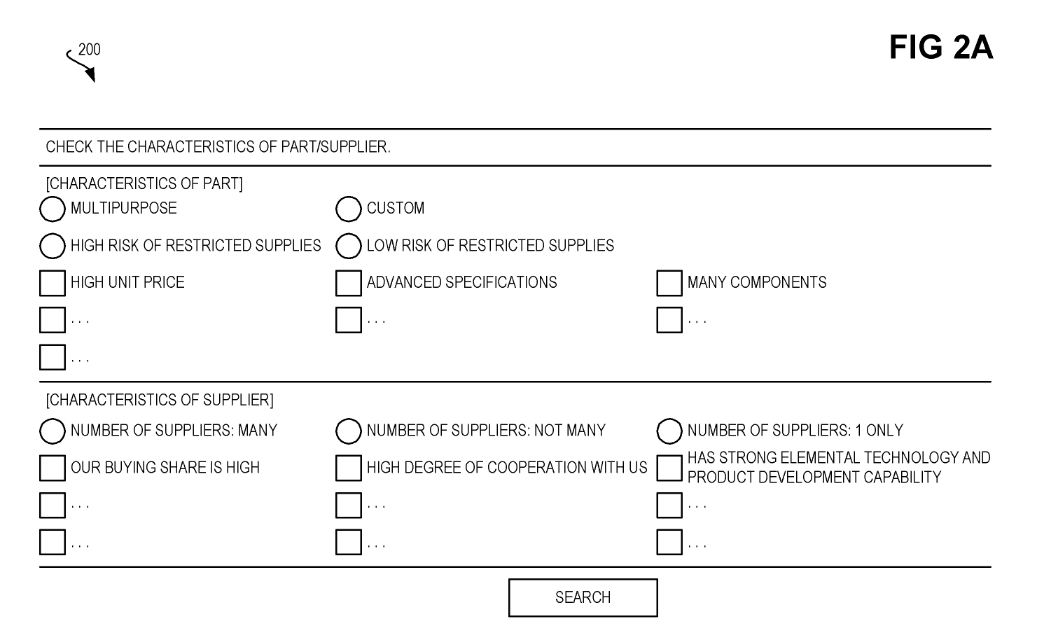

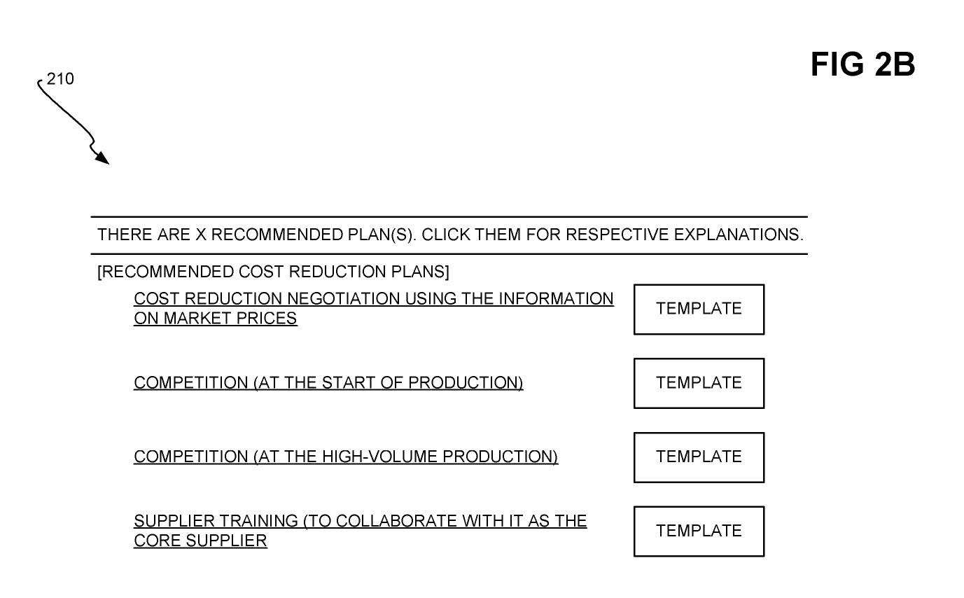

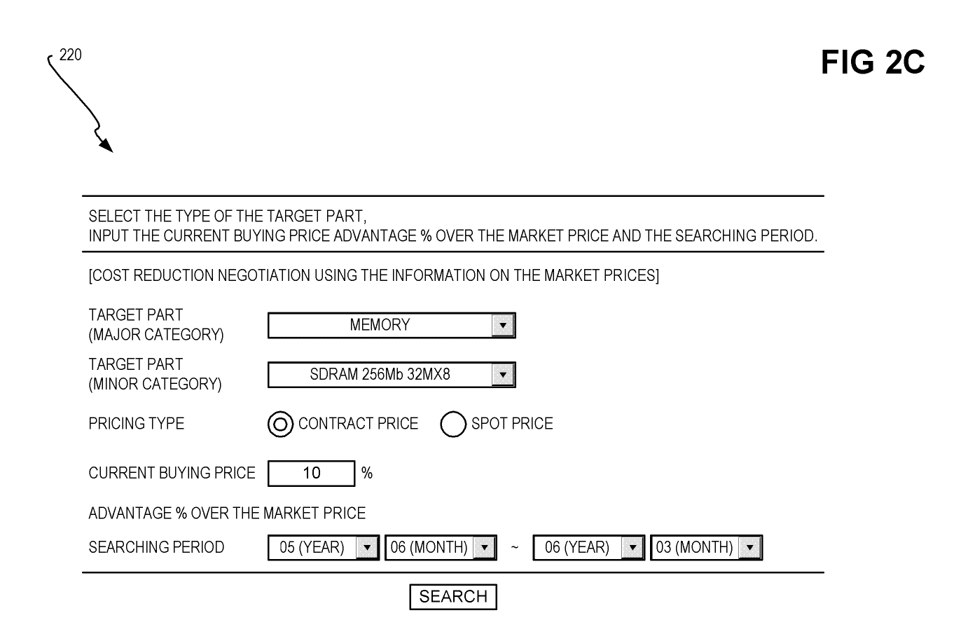

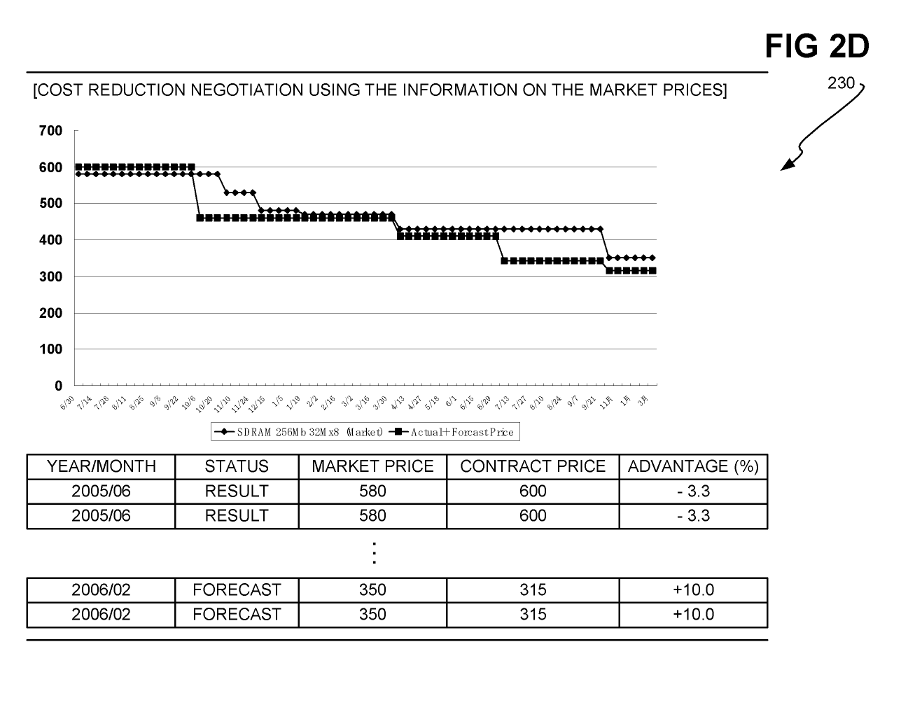

FIG. 2A shows a graphical user interface (GUI) 200 by which a user is able to provide the part characteristics and the supplier characteristics to the method 100 of FIG. 1 in part 104, according to an embodiment of the invention. The top half of the GUI 200 allows a user to select part characteristics, whereas the bottom half of the GUI 200 allows a user to select supplier characteristics.

Characteristics that are mutually exclusive of one another are selectable by the user via circular radio buttons. For instance, whether a part is multipurpose and whether a part is custom are two part characteristics that are mutually exclusive of one another. Therefore, if a user selects the former, the latter is automatically deselected, and vice-versa. Likewise, whether there is a high risk of restricted supplies for a part and whether there is a low risk of restricted supplies for a part are two part characteristics that are mutually exclusive of one another. If a user selects the former, the latter is automatically deselected, and vice-versa.

By comparison, characteristics that are not mutually exclusive of one another are selected by the user via rectangular checkboxes. For example, whether the buying share from a supplier for a given part is high, whether there has been a high degree of cooperation with a supplier, and whether the supplier has strong elemental technology and product development capability are three supplier characteristics that are not dependent on one another. A user can select any combination of these three supplier characteristics, for instance.

Referring back to FIG. 1, the method 100 then determines one or more templates, based on the part characteristics and the supplier characteristics received from the user (106). A template in one embodiment is particular to one or more unique pairs of part characteristics and supplier characteristics. That is, for a unique pair including a part characteristic and a supplier characteristic, there are one or more templates. A template corresponds to a cost reduction plan.

More specifically, a template includes a number of parameters for which values are to be received from the user, and that are associated in some way with the part characteristics and the supplier characters of the unique pairs to which the template corresponds. The template also includes logic to generate its corresponding cost reduction plan, based on the parameter values received from the user. Thus, a template can be considered as a general cost reduction plan, which becomes specific to a particular scenario based on the parameter values entered by the user.

Templates can be generated in any of a number of different ways, as can be appreciated by those of ordinary skill within the art. In one embodiment, for instance, expert buyers may be interviewed, and their knowledge and experience encapsulated within a number of templates. That is, by using conventional or other techniques, the knowledge and experience of expert buyers may be transformed methodically into templates. The manner by which templates can be generated, however, is beyond the scope of the present patent application, though those of ordinary skill within the art can understand how to generate such templates.

For X part characteristics and Y supplier characteristics, there are X times Y unique part characteristic-supplier characteristic pairs. Each of these unique pairs is associated with a number of templates. However, a given template can be associated with more than one unique part characteristic-supplier characteristic pair.

In one embodiment, the templates based on the part characteristics and the supplier characteristics received from the user are determined in part 106 of the method 100 by performing parts 108 and 110. First, for each unique part characteristic-supplier characteristic pair of the part characteristics and the supplier characteristics received from the user, one or more templates that correspond to this unique pair are retrieved from a previously established database (108). The result of performing part 108 is a list of a number of templates. Thereafter, the templates that are used are assembled as all the unique templates retrieved from the database (110).

For example, consider the situation where there is one part characteristic X1 and two supplier characteristics Y1 and Y2. As such, there are two unique part characteristic-supplier characteristic pairs: X1 and Y1, and X1 and Y2. In part 108, templates T1, T2, and T3 may be retrieved from the database as corresponding to the unique pair X1-Y1, and templates T2, T3, and T4 may be retrieved from the database as corresponding to the unique pair X1-Y2. Therefore a total of six templates are retrieved in part 108, but two templates, T2 and T3, are associated with each pair, such that there are only a total of four unique templates. These four unique templates, T1, T2, T3, and T4, are those that are assembled in part 110 as the templates determined in part 106 of the method 100.

Upon the templates being determined, the user is enabled to select a desired template (112). For instance, FIG. 2B shows a GUI 210 by which a user is able to select a desired template in part 112 of the method 100 of FIG. 1, according to an embodiment of the invention. Four different and unique templates have been determined based on the part characteristics and the supplier characteristics received from the user, and are displayed to the user within the GUI 210. The user then simply selects the template button next to the desired template.

Referring back to FIG. 1, the method 100 then receives from the user values for the parameters of the desired template selected by the user (114). As has been described, each template has one or more parameters. The values for the parameters transform the template from being a general description of a cost reduction plan, to a particular description of the cost reduction plan pertaining to the particular situation of the user.

FIG. 2C shows a GUI 220 by which a user enters values for the parameters of the desired template selected in part 114 of the method 100 of FIG. 1, according to an embodiment of the invention. The template selected is particularly “cost reduction negotiation using information on market prices.” The parameters that the user has to enter values for include a target part, both its general (or major) category and its specific (or minor) category, pricing type, current buying price advantage over the market price as a percentage, and a searching period. The GUI 220 enables the user to enter values for all these parameters.

Referring back to FIG. 1, the method 100 displays the cost reduction plan costing to the desired template selected based on the values for the parameters of the template as received from the user (116), for checking (i.e., review or analysis) by the user. For instance, the logic of the desired template generates this cost reduction plan based on the parameter values entered by the user. The user thus is able to generate and analyze a cost reduction plan, even if he or she is not an experienced buyer, due to the intelligence built into the templates.

FIG. 2D shows a GUI 230 by which the cost reduction plan may be displayed to the user in part 116 of the method 100 of FIG. 1, according to an embodiment of the invention. For the particular template “cost reduction negotiation using information on market prices,” there are two aspects of the plan displayed. The top half of the GUI 230 shows a graph depicting, for instance, the difference between the actual purchase price and the market price during a given period of time. The bottom half of the GUI 230 shows a table that automatically calculates the target purchase price by adding the advantage ratio of the contract price to the forecast by the market price information that may be contained within the template itself.

Referring back to FIG. 1, the method 100 finally allows or enables the user to save the cost reduction plan corresponding to the desired template based on the parameter values received from the user (118). As such, the user can save the plan, and revisit the plan at a later time or date. The method 100 thus provides a framework by which even inexperienced users are able to generate cost reduction plans from desired part and supplier characteristics. This is achieved by having templates, associated with part characteristic-supplier characteristic pairs, which correspond to cost reduction plans and contain the logic necessary to generate the plans based on input parameter values. The user only has to know which supplier and part characteristics are desired, and then only has to select a desired cost reduction plan and enter parameter values for that plan in order to generate the plan for review, analysis, and other checking.

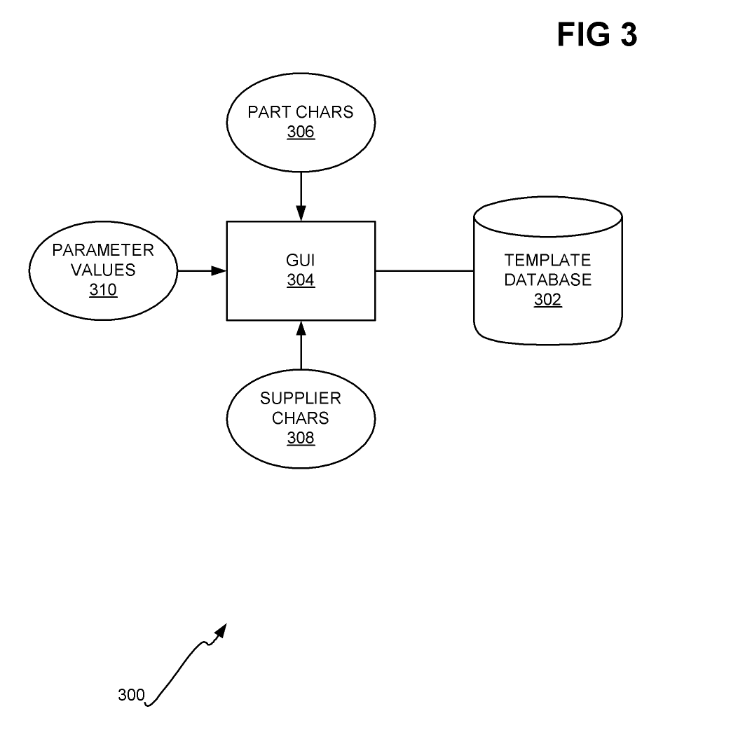

FIG. 3 shows a rudimentary system 300, according to an embodiment of the invention. The system 300 is depicted in FIG. 3 as including a template database 302 and a graphical user interface (GUI) 304. As can be appreciated by those of ordinary skill within the art, the system 300 will typically include other components, in addition to those depicted in FIG. 3, such as processors, memory, and so on.

The template database 302 stores a number of templates, as have been described. Each template corresponds to one or more unique part characteristic-supplier characteristic pairs. Each template includes a number of parameters, and logic for generating a cost reduction plan based on values for the parameters, as has been described.

The GUI 304 can encompass in one embodiment the various GUI's that have been described in relation to FIGS. 2A-2D. Thus, the GUI 304 is that by which to receive from a user the selection of one or more part characteristics 306 and one or more supplier characteristics 308. Based on the part characteristics 306 and the supplier characteristics 308 selected, the GUI 304 displays one or more of the templates within the database 302 that match unique pairs of the characteristics 306 and 308. The GUI 304 then enables a user to select a desired template from these templates, and is that by which a user enters parameter values 310 for the parameters of the desired template selected. Thereafter, the GUI 304 displays the cost reduction plan associated with the desired template as generated by the logic of the template based on the parameter values entered by the user.

It is noted that, although specific embodiments have been illustrated and described herein, it will be appreciated by those of ordinary skill in the art that any arrangement calculated to achieve the same purpose may be substituted for the specific embodiments shown. This application is thus intended to cover any adaptations or variations of embodiments of the present invention. Therefore, it is manifestly intended that this invention be limited only by the claims and equivalents thereof.

We claim:

1. A method for purchasing cost reduction planning and checking comprising:
receiving from a user one or more part characteristics and one or more supplier characteristics;
determining one or more templates based on the part characteristics and the supplier characteristics, each template corresponding to a cost reduction plan; and,
in response to the user selecting a desired template,
receiving from the user values for one or more parameters of the desired template;
displaying the cost reduction plan corresponding to the desired template based on the values for the parameters of the desired template received from the user, for checking by the user.

2. The method of claim 1, wherein each template comprises:
the parameters for which the values are to be received from the user and associated with one or more of the part characteristics and one or more of the supplier characteristics; and,
logic to generate the cost reduction plan to which the template corresponds based on the values for the parameters of the template.

3. The method of claim 2, wherein displaying the cost reduction plan corresponding to the desired template based on the values for the parameters of the desired template received from the user comprises the logic generating the cost reduction plan based on the values for the parameters of the template received from the user.

4. The method of claim 1, wherein determining the templates based on the part characteristics and the supplier characteristics comprises:
for each of one or more unique pairs of one of the part characteristics and one of the supplier characteristics, retrieving from a database of templates one or more templates corresponding to the unique pair; and,
assembling the templates as all unique templates retrieved from the database.

5. The method of claim 4, wherein one or more of the templates within the database are associated with a plurality of unique pairs of part characteristics and supplier characteristics.

6. The method of claim 1, wherein at least one of the part characteristics are each selected from a group of potential part characteristics, the group of potential part characteristics divided into a plurality of sub-groups, the user able to select at most one potential part characteristic from each sub-group.

7. The method of claim 1, wherein the part characteristics are each selected from a group of potential part characteristics essentially consisting of: whether a part is multipurpose; whether the part is custom; whether the part has a high risk of restricted supply; whether the part has a low risk of restricted supply; whether the part has a high unit price; whether the part requires advanced specifications; and, whether the part has many components.

8. The method of claim 1, wherein at least one of the supplier characteristics are each selected from a group of supplier characteristics, the group of potential part characteristics divided into a plurality of sub-groups, the user able to select at most one potential part characteristic from each sub-group.

9. The method of claim 1, wherein the supplier characteristics are each selected from a group of potential supplier characteristics essentially consisting of: whether there are many suppliers for a part; whether there are not many suppliers for the part; whether there is only one supplier for a part; whether a percentage of all parts produced by a supplier will be purchased is high; whether the supplier has a high degree of prior cooperation; and, whether the supplier has strong elemental technology and product development capability.

10. The method of claim 1, wherein the part characteristics, the supplier characteristics, and the values for the parameters of the desired template are received from the user through a graphical user interface (GUI).

11. The method of claim 1, further comprising:
authenticating the user prior to receiving the part characteristics and the supplier characteristics from the user; and,
enabling the user to save the cost reduction plan corresponding to the desired template based on the values for the parameters of the desired template received from the user.

12. A system comprising:
a database of templates, each template corresponding to one or more unique pairs of part characteristics and supplier characteristics comprising:
one or more parameters for which values are to be received; and,
logic to generate a cost reduction plan associated with the template based on the values for the parameters of the template; and,
a graphical user interface by which to receive from a user: selection of one or more specified part characteristics and one or more specified supplier characteristics, selection of a desired template from one or more templates matching each of one or more unique pairs of the specified part characteristics and the specified supplier characteristics, and the values for the parameters of the desired template,
wherein the graphical user interface is further to display the cost reduction plan associated with the desired template as generated by the logic of the desired template based on the values for the parameters received from the user.

13. The system of claim 12, wherein at least one of the specified part characteristics are each selected from a group of potential part characteristics, the group of potential part characteristics divided into a plurality of sub-groups, the user able to select at most one potential part characteristic from each sub-group.

14. The system of claim 12, wherein the specified part characteristics are each selected from a group of potential part characteristics essentially consisting of: whether a part is multipurpose; whether the part is custom; whether the part has a high risk of restricted supply; whether the part has a low risk of restricted supply; whether the part has a high unit price; whether the part requires advanced specifications; and, whether the part has many components.

15. The system of claim 12, wherein at least one of the specified supplier characteristics are each selected from a group of supplier characteristics, the group of potential part characteristics divided into a plurality of sub-groups, the user able to select at most one potential part characteristic from each sub-group.

16. The system of claim 12, wherein the specified supplier characteristics are each selected from a group of potential supplier characteristics essentially consisting of: whether there are many suppliers for a part; whether there are not many suppliers for the part; whether there is only one supplier for a part; whether a percentage of all parts produced by a supplier will be purchased is high; whether the supplier has a high degree of prior cooperation; and, whether the supplier has strong elemental technology and product development capability.

17. The system of claim 12, wherein the graphical user interface is further to:
authenticate the user prior to receiving the specified part characteristics and the specified supplier characteristics from the user; and,
enable the user to save the cost reduction plan associated with the desired template based on the values for the parameters of the desired template received from the user.

18. An article of manufacture comprising:
a tangible computer-readable medium; and,
means in the medium for
receiving from a user: selection of one or more specified part characteristics and one or more specified supplier characteristics, selection of a desired template from one or more templates matching each of one or more unique pairs of the specified part characteristics and the specified supplier characteristics, and values for one or more parameters of the desired template by which the desired template generates a corresponding cost reduction plan; and,
displaying the cost reduction plan corresponding to the desired template as generated by the desired template based on the values for the parameters received from the user.

19. The article of manufacture of claim 18, wherein the specified part characteristics are each selected from a group of potential part characteristics essentially consisting of: whether a part is multipurpose; whether the part is custom; whether the part has a high risk of restricted supply; whether the part has a low risk of restricted supply; whether the part has a high unit price; whether the part requires advanced specifications; and, whether the part has many components.

20. The article of manufacture of claim 18, wherein the specified supplier characteristics are each selected from a group of potential supplier characteristics essentially consisting of: whether there are many suppliers for a part; whether there are not many suppliers for the part; whether there is only one supplier for a part; whether a percentage of all parts produced by a supplier will be purchased is high; whether the supplier has a high degree of prior cooperation; and, whether the supplier has strong elemental technology and product development capability.
